(19) United States
(12) Patent Application Publication
(10) Pub. No.: US 2026/0051242 A1
(43) Pub. Date: Feb. 19, 2026

(54) SYSTEM

(71) Applicant: SOFTBANK GROUP CORP., Tokyo (JP)

(72) Inventor: Junji ISHIKAWA, Tokyo (JP)

(73) Assignee: SOFTBANK GROUP CORP., Tokyo (JP)

(21) Appl. No.: 19/299,417

(22) Filed: Aug. 14, 2025

(30) Foreign Application Priority Data
Aug. 16, 2024 (JP) 2024-137131

(51) Int. Cl. G08G 1/07; G06N 3/0475; G06V 20/54; G08G 1/01

(52) U.S. Cl. CPC G08G 1/07; G06N 3/0475; G06V 20/54; G08G 1/0145

(57) ABSTRACT

A system includes a processor that: collects traffic video data using a data acquisition device installed at a traffic signal, collects weather data using a data acquisition device, aggregates data from the data acquisition devices via a high-speed communication network using a data aggregation device, analyzes the data transmitted from the data aggregation device using an analysis unit, and controls the traffic signal based on analysis results from the analysis unit.

### CROSS-REFERENCE TO RELATED APPLICATION

This application is based on and claims priority under 35 USC 119 from Japanese Patent Application No. 2024-137131 filed on Aug. 16, 2024, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional traffic management systems face challenges in efficiently managing traffic flow, quickly responding to traffic accidents, enforcing traffic regulations, and predicting road hazards such as freezing or snowfall. Existing systems often lack real-time integration of diverse data sources, dynamic signal control based on comprehensive analysis, and seamless communication for coordination among various devices, resulting in suboptimal traffic safety and road utilization.

### SUMMARY

To solve these problems, the present invention provides a system including a processor that collects traffic video data and weather data via data acquisition devices installed at traffic signal locations, aggregates these data via a high-speed communication network using a data aggregation device, analyzes the aggregated data with an analysis unit, and dynamically controls the traffic signals in response to analysis results. The processor further enables identification of traffic volume, detection of traffic accidents, recognition of traffic violation vehicles, and prediction of road freezing or snowfall, thereby enabling proactive and efficient management of traffic flow and road safety.

“Processor” means a computational unit or device configured to execute instructions and perform operations as described in the claims.

“Data acquisition device” means an apparatus capable of obtaining specific types of data, such as traffic video data or weather data, from a designated location.

“Traffic signal” means an installation at an intersection or along a roadway used to control vehicular and pedestrian traffic by displaying lights of different colors.

“High-speed communication network” means a data transmission network capable of rapidly transferring large amounts of data between devices, such as 5G or fiber-optic networks.

“Data aggregation device” means a device which collects, combines, and organizes data received from multiple data acquisition devices for further processing or analysis.

“Analysis unit” means a system or module which processes and evaluates aggregated data to extract meaningful information, such as identifying traffic conditions or predicting hazards.

“Control device” means an apparatus or system responsible for sending instructions to traffic signals to alter their operational states based on received analysis results.

“Traffic video data” means visual information or images captured by cameras installed to monitor traffic conditions at intersections or roadways.

“Weather data” means information regarding atmospheric conditions, including temperature, humidity, wind speed, and other meteorological variables pertinent to traffic management.

“Traffic volume” means the number of vehicles passing a given point on a roadway within a specified time period.

“Traffic accident” means an incident involving one or more vehicles that results in property damage, injury, or obstruction of normal traffic flow.

“Traffic violation vehicle” means a vehicle identified as having infringed upon traffic regulations, such as exceeding speed limits or ignoring traffic signals.

“Road freezing or snowfall” means hazardous roadway conditions resulting from low temperatures or precipitation, which can affect the safety and flow of traffic.

“Lighting state” means the current operational mode or color display of a traffic signal, such as red, yellow, or green illumination.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

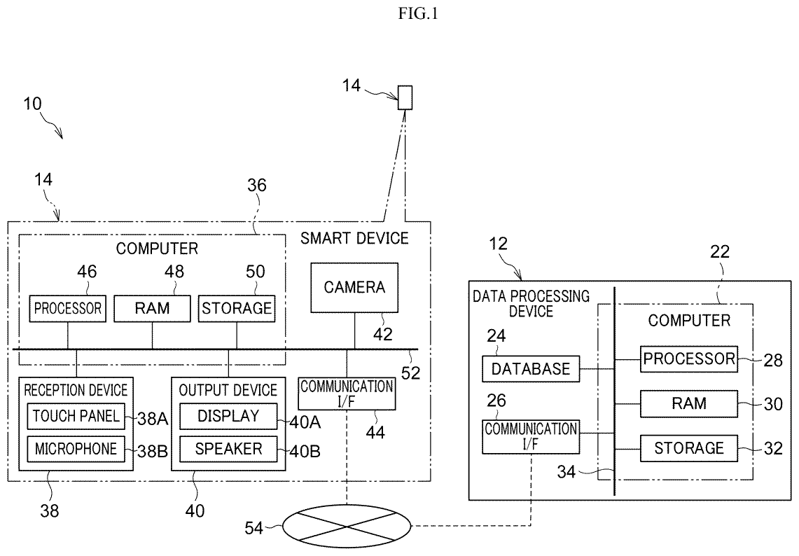

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

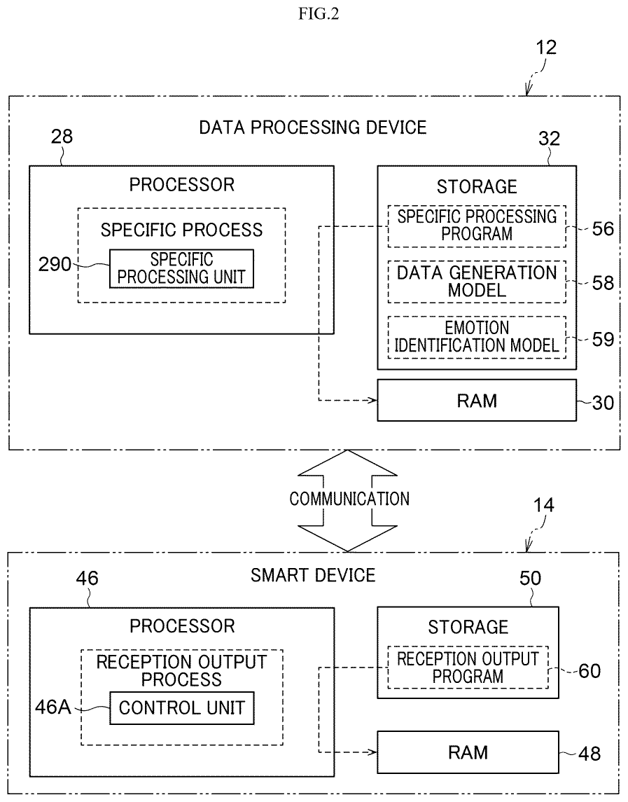

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional traffic management systems have difficulties in performing real-time control of traffic signals in accordance with traffic volume and environmental conditions. As a result, problems such as traffic congestion, delayed identification of traffic violations, insufficient accident response, and inadequate management of road freezing or snow accumulation frequently arise. There is a need for an effective system that can aggregate data from multiple sources, analyze it in real time, and provide responsive and dynamic control of traffic infrastructure to promote safety, efficient traffic flow, and optimal operation under various road and weather conditions.

The specific processing by the specific processing unit 290 of the data processing device 12 in Example 1 is realized by the following means.

The present invention provides a server including a processor configured to acquire information from a data recording device via a communication platform, collect traffic and environmental data using multiple measurement devices, aggregate the data through storage and communication devices, perform real-time alignment and inconsistency resolution, analyze situational information with machine learning-based image and character recognition, and dynamically control traffic equipment accordingly. This enables real-time, data-driven traffic management that rapidly identifies violations or accidents, accurately predicts hazardous road conditions, and optimally adjusts traffic signal operations for improved traffic safety and efficient flow under variable conditions.

The term “processor” refers to a hardware or virtual computational unit that executes machine instructions to carry out data processing and control functions within the system. The term “communication platform” refers to an integrated hardware and software arrangement that enables data transmission and reception between devices within the traffic control infrastructure, typically via a wired or wireless network.

The term “data recording device” refers to an apparatus that captures and stores digital information, such as video data, sensor data, or other measurement outputs, for subsequent processing.

The term “traffic information data” refers to any data relating to the dynamic state of vehicular movement and flow on roadways, including vehicle counts, congestion states, and traffic incidents.

The term “environmental information data” refers to data collected from physical sensors that represent conditions such as temperature, humidity, wind speed, precipitation, or other environmental variables relevant to road and traffic safety.

The term “measurement device” refers to any sensing apparatus or system, such as a video camera or environmental sensor, used to measure, detect, or monitor traffic or environmental parameters.

The term “data transmission device” refers to an apparatus or module that communicates collected data to aggregation or storage means over a communication network. The term “data storage device” refers to any medium or system, such as internal memory or external storage hardware, used to store acquired and processed data for analysis and retrieval.

The term “high-speed communication network” refers to a network infrastructure that supports the fast and secure transmission of data, such as fiber optic, 4G, or 5G cellular communications.

The term “time-series alignment” refers to a data processing method where records acquired at different times or from different sources are synchronized or matched according to their timestamps to ensure consistency and accurate analysis.

The term “data inconsistency resolution” refers to a process for detecting and correcting mismatches, gaps, or conflicts in the collected datasets to create coherent and reliable information for analysis.

The term “analysis device” refers to a computational system or module that processes aggregated data in order to interpret, recognize patterns, or extract insights, often with the assistance of artificial intelligence techniques.

The term “image recognition processing” refers to a computational technique that analyzes digital image data to detect, identify, or classify visual objects, such as vehicles, license plates, or incidents.

The term “machine learning model” refers to a computational framework that executes learned algorithms or patterns for predictive analytics, pattern recognition, or decision-making tasks based on historical and real-time data.

The term “character recognition technology” refers to a technique, such as optical character recognition (OCR), used to detect and convert characters from image data into machine-encoded text.

The term “vehicle identification information” refers to attributes or features that uniquely distinguish and identify vehicles, such as license plate numbers recognized from video data.

The term “traffic control equipment” refers to any device or instrumentality, such as traffic signal controllers or actuators, used to manage, modify, or direct the flow of vehicular and pedestrian traffic.

The term “analysis result” refers to the output generated by the analysis device, comprising interpreted traffic, environmental, or incident data used for real-time decision-making and control.

The term “visualization information” refers to graphical, textual, or tabular representations of analyzed data displayed in real time to facilitate user understanding and operational decision-making.

The term “operational interface” refers to a user-accessible platform, such as a graphical dashboard or control panel, through which users interact with the system, monitor data, and issue commands.

The term “object detection algorithm” refers to a computational procedure that identifies and localizes objects, such as vehicles or pedestrians, within image or video streams for analysis purposes.

The term “identification technology” refers to any software or hardware solution used to uniquely distinguish or classify entities, such as vehicles, based on recognized features.

The term “violation target information management means” refers to a data management function that stores, updates, and references records of vehicles or individuals associated with traffic violations for use in detection or enforcement.

The term “signal control information” refers to parameters or instructions for adjusting the operation of traffic control equipment, particularly with respect to timing and priority settings.

The term “emergency response control” refers to an automated or manual function that modifies traffic signal or control device behavior in order to facilitate rapid and safe passage for emergency vehicles or respond to incidents.

The term “route optimization” refers to a process or function by which the system dynamically adjusts traffic flow or signal settings to achieve optimal travel times, reduce congestion, or enhance overall network performance.

This invention can be implemented by configuring a traffic management system including a server, multiple terminals, and user-accessible interfaces. The system is designed to acquire, process, analyze, and display traffic and environmental data in real time, and dynamically control traffic control equipment to optimize road safety and efficiency.

The terminal includes hardware such as network cameras, environmental sensors (for instance, temperature and humidity sensors), communication modules, and programmable logic controllers. These components may be represented by general-purpose network cameras, generic environmental sensors, general wireless or wired communication modules (such as those supporting 4G/5G standards), and standard programmable logic controllers. The terminal executes software modules responsible for capturing image and sensor data, serializing the data using standard formats such as JSON or CSV, and transmitting the data to the server via secure communication protocols, such as HTTPS or MQTT.

The server is equipped with high-performance processors and storage devices, such as general computing servers and disk drives. The server executes software to receive the transmitted data, store it in a database (for example, a relational database system), and perform data preprocessing steps including time alignment and inconsistency resolution. The server is further configured with a machine learning-based analysis module, which may use open-source libraries (e.g., a deep learning inference engine, object detection models, and optical character recognition engines) to analyze video streams for vehicle detection and license plate recognition. The server employs a decision model to evaluate traffic and environmental risks, such as congestion or road surface hazards, based on the analyzed data.

The server generates control instructions based on the analysis results and transmits these instructions to the terminal devices operating the traffic control equipment. The instructions may include changes to signal timing, activation of emergency priority signals, or other operational adjustments. The terminal receives these commands, interprets them, and communicates with the traffic control equipment using standard device interfaces, such as those provided in programmable logic controllers or actuator interfaces.

The user accesses the system through an operational interface, such as a dashboard implemented using general visualization software (e.g., a data dashboard). The user interface provides real-time displays of traffic flow, accident alerts, road conditions, and violation detections. The user can also use provided interface functions to issue new control directives, request specific data reports, or receive notifications. The system can generate analytical summaries and detailed incident reports, which users may export or share.

For example, in a metropolitan area, the terminal collects live video and sensor data at a busy intersection and transmits this information to the server in real time. The server analyzes the video to count vehicles and detect traffic incidents, uses optical character recognition technology to extract license plate data, and evaluates weather data to predict hazardous road conditions. Based on the analysis, the server issues a command to extend the green signal duration for identified heavy traffic lanes, and also generates a dashboard alert for road freezing risk. The user reviews this information via the dashboard and may further restrict vehicle access or trigger targeted enforcement.

Examples of prompt sentences for a generative AI model that may be employed within this system include following.

“Explain, step by step, how the server analyzes incoming sensor and video data to identify a road icing risk and notifies the field signal terminal.”

“Describe in detail how the terminal matches weather sensor readings with traffic video frames during the aggregation process.”

“Provide a flow description of how a user uses the dashboard to monitor emergencies and remotely change traffic signal behavior.”

This configuration enables real-time, flexible, and data-driven management and control of traffic infrastructure, supporting advanced incident detection, environmental risk prediction, responsive signal control, and user interaction for enhanced safety and operational efficiency.

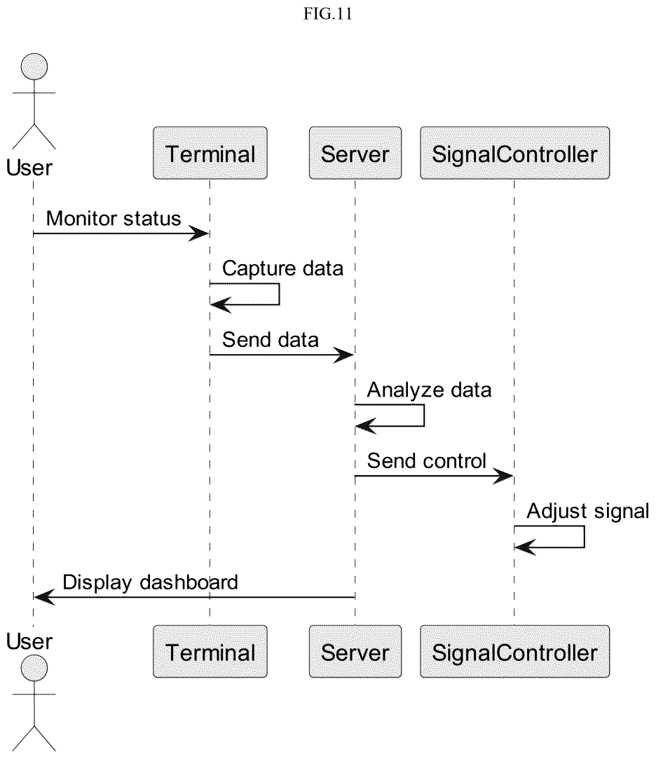

The following describes the processing flow using FIG. 11.

### Step 1:

The terminal collects real-time traffic image data and environmental sensor data.

Input: Sensed physical environment (vehicles, weather conditions, road surface).

Output: Raw image files (such as video streams) from network cameras and environmental readings (temperature, humidity, wind speed) from sensors, each with timestamps.

The terminal activates its camera to capture video for every frame, uses sensor drivers to record environmental conditions every few seconds, and stores this data locally with precise time labels.

### Step 2:

The terminal packages the collected image and sensor data for transmission.

Input: Locally stored video files and sensor data logs with metadata.

Output: Bundled data packets in standardized format (such as JSON or binary archive) ready for network transmission.

The terminal associates sensor readings to appropriate video frames based on timestamps, serializes the combined data, and compresses the files to reduce network load.

### Step 3:

The terminal transmits the bundled data to the server via a secure communication channel.

Input: Data packets prepared for transmission.

Output: Data packets received by the server; local transmission logs.

The terminal establishes a connection over a high-speed wireless or wired network using a secure protocol, authenticates the server, and sends data using protocols such as HTTPS or MQTT.

### Step 4:

The server receives, stores, and preprocesses the incoming data.

Input: Data packets containing synchronized video and sensor information.

Output: Preprocessed and time-aligned records stored in the server's database.

The server validates data integrity, checks for missing or corrupted files, aligns sensor values with corresponding video frames, and writes the cleaned and aligned data to a structured database.

### Step 5:

The server analyzes the synchronized data using machine learning and computer vision algorithms.

Input: Preprocessed video data and associated environmental sensor data.

Output: Analysis results, including vehicle counts, identification of abnormal traffic events, recognized vehicle identification data, and road condition risk levels.

The server runs object detection models on video to count vehicles and detect incidents, applies character recognition to extract license plate numbers, and uses weather readings in a predictive model to estimate road hazards like icing or accumulation.

### Step 6:

The server generates control commands for traffic control equipment based on analysis results.

Input: Results from data analysis (e.g., congestion level, detected incidents, violation information, hazard predictions).

Output: Instruction sets or policy changes dispatched to traffic control terminals.

The server determines optimal signal timing, emergency signal activations, or new restrictions, formulates appropriate command messages, and prepares them for downstream devices.

### Step 7:

The terminal receives control commands and adjusts local signal controllers or display equipment.

Input: Control instructions received from the server.

Output: Updated equipment states, such as adjusted signal phase durations or activated priority signals.

The terminal interfaces with traffic signal controllers, interprets the adjustment commands, and modifies device behavior—such as extending green light duration or initiating emergency response modes—accordingly.

### Step 8:

The user monitors system status and interacts with operational dashboards.

Input: Visualization data streams and incident notifications from the server.

Output: User-initiated responses, new control directives, or data export requests.

The user reviews graphics showing live traffic and environmental analysis, explores incident details, and may interact with the system by issuing additional remote control requests (such as implementing speed restrictions or requesting violation reports).

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional traffic control systems are limited in their ability to utilize real-time traffic and environmental data effectively. They typically lack the means to rapidly detect and respond to congestion, incidents, or hazardous environmental conditions. Furthermore, existing systems do not incorporate user emotional states when determining the manner or urgency of notifications, nor do they support the delivery of personalized traffic information and remote command execution by operators. As a result, these limitations can lead to inefficient traffic flow, delayed emergency response, and insufficiently tailored communication with road users, ultimately impacting safety and societal welfare.

The specific processing by the specific processing unit 290 of the data processing device 12 in Application Example 1 is realized by the following means.

The present invention provides a server including a processor configured to receive and aggregate traffic image data, environmental sensor data, and user emotion data via a communication module; analyze such data to determine traffic status, environmental risks, and user emotional states; dynamically control signal display operation and notification methods in response to the analyzed data; and visualize the information for remote users while permitting remote command input. This enables real-time optimization of signal control, personalized notifications, and remote monitoring and command by authorized users, thereby improving traffic flow, safety, and responsiveness to both objective and subjective situational factors.

The term “processor” refers to a computing device or central processing unit configured to execute instructions, perform data processing, and control the operation of other system components.

The term “information acquisition unit” refers to a hardware module or device, such as a sensor or camera, designed to collect data including image information, environmental information, or user-related data from a specified area.

The term “communication module” refers to a hardware or software component that enables data transmission between the information acquisition unit and the processor, often utilizing wired or wireless communication networks.

The term “image information” refers to data in the form of visual representations, such as still images or video streams, captured by cameras or imaging sensors.

The term “environmental information” refers to data related to physical surroundings, including but not limited to temperature, humidity, wind speed, and other meteorological or environmental factors.

The term “aggregation module” refers to a component or function in the system that collects, organizes, and temporarily stores incoming data from multiple information acquisition units before transmission to the processor or analysis module.

The term “analysis module” refers to a computational component or software that processes and interprets aggregated data to extract meaningful information, detect anomalies, or generate predictions.

The term “information analysis module” refers to a processing unit responsible for analyzing received data, such as image and environmental information, and generating actionable insights for system control.

The term “control module” refers to a system component that receives analysis results and issues operational commands to other subsystems, such as changing the state of signal lights.

The term “signal display module” refers to a hardware device, such as a traffic signal, whose operational state is managed by the control module to regulate traffic flow. The term “emotion estimation model” refers to an algorithm or machine learning model that analyzes data, such as facial images or voice recordings, to predict or classify human emotional states.

The term “notification method” refers to the manner or protocol by which information or alerts are conveyed to users, which may include audio, visual, or electronic communications.

The term “terminal” refers to an endpoint device, such as a personal computer, mobile device, or operator console, used for data input, visualization, or system interaction. The term “remote user” refers to an operator or authorized person who accesses and interacts with the system from a location physically separated from the processor or primary system components.

The term “object” refers to any entity detected within the image information, such as a vehicle, pedestrian, or other moving or stationary element relevant to traffic control.

The term “non-compliant moving object” refers to an object detected in the image information that is identified as violating applicable rules or regulations, such as traffic laws.

The term “surface status” refers to the current or predicted physical state of a roadway surface, such as normal, wet, icy, or snowy, as determined from environmental information.

The term “information visualization function” refers to a system capability that presents real-time or processed data to users in a human-interpretable format via terminals or displays.

The term “command” refers to an operational instruction issued by a remote user for the purpose of system control, such as adjusting signal parameters or initiating emergency protocols.

An embodiment for implementing the invention will be described below. The system comprises a server equipped with at least one processor, a plurality of terminals functioning as information acquisition units, communication modules supporting high-speed data transfer, aggregation modules, analysis modules, control modules, and signal display modules such as traffic signal devices.

The terminals include cameras to acquire image information, weather sensors to acquire environmental information such as temperature, humidity, and wind speed, and input devices such as microphones and additional cameras for capturing user facial and audio data. These terminals are positioned at traffic intersections or other monitoring locations. The communication modules, which may utilize wireless technology such as 5G, transmit the obtained data from the terminals to the aggregation module.

The aggregation module temporarily stores and organizes the incoming data (traffic images, weather readings, and emotion-related user data). The aggregated information is then transmitted to the information analysis module located at the server. The server operates software such as an OpenCV-based vehicle detection module for analyzing images, an OCR library (for example, Tesseract or EasyOCR) for license plate recognition, and a time series prediction model such as ARIMA for environmental forecasting (e.g., surface freezing risk). The server also executes an emotion estimation model using deep learning (such as a CNN for facial emotion and OpenSMILE or PyAudioAnalysis for voice features). The information analysis module processes the incoming aggregated data to extract vehicle counts, detect traffic incidents or violations, forecast environmental hazards, and estimate the emotion state of users near the intersection.

Based on the analysis results, the control module dynamically determines the optimal display status of the signal display module. For example, in response to detected traffic congestion, the server commands the terminal (traffic signal controller) to extend the green-light duration. If an accident or emergency is detected, the server instructs the system to enable emergency signal sequences and sends notifications to relevant parties.

The server further utilizes the estimated user emotion state to personalize the method and priority of system notifications: when high stress in road users is recognized, the server prioritizes the issuance of emergency alerts or guidance, adjusting the notification protocol accordingly. Notification methods may include push notifications to mobile terminals, audio-visual alerts, or dedicated information panels near the signal.

A terminal or an operator console provides an interface for remote users, such as law enforcement officers or municipal staff, to monitor real-time analytics, receive notifications, and send remote commands for traffic regulation or emergency response. The server maintains a web-based dashboard accessible via secure authentication, where users can visualize current traffic, environmental, and emotion metrics, and initiate actions as necessary. For implementation, the system may employ hardware such as industrial cameras, environmental sensor modules, edge computing terminals, 5G communication devices, general-purpose computing servers, and human-machine interfaces. The software may utilize OpenCV, Tesseract, EasyOCR, ARIMA, PyTorch or TensorFlow for image, text, time series, and emotion analysis. Web dashboards may be built using standard web technologies and API integration for command transfer.

A concrete example is as follows: During peak hours at a city intersection, cameras transmit live video, sensors provide environmental data, and microphones and cameras collect facial and audio data of nearby users. All data are aggregated and analyzed by the server. Upon detecting 20 vehicles in congestion, three vehicles committing traffic violations, and a high risk of surface freezing, while also recognizing multiple users exhibiting stress, the server dynamically extends the green signal, activates emergency protocols if needed, and sends high-priority alerts to affected users and authorities. Authorized users remotely access the dashboard, review analytics, and execute traffic control actions.

A prompt sentence example provided to a generative AI model is as follows.

“Design a system that acquires real-time traffic images, weather sensor data, and user emotion data from multiple terminals, processes this information at a central server using computer vision, OCR, time-series forecasting, and emotion estimation models, and dynamically controls traffic signals and notification methods. Include functionality for remote monitoring, visualization, and command input for authorized users. Generate code for data collection, analysis, control, and dashboard integration as described.”

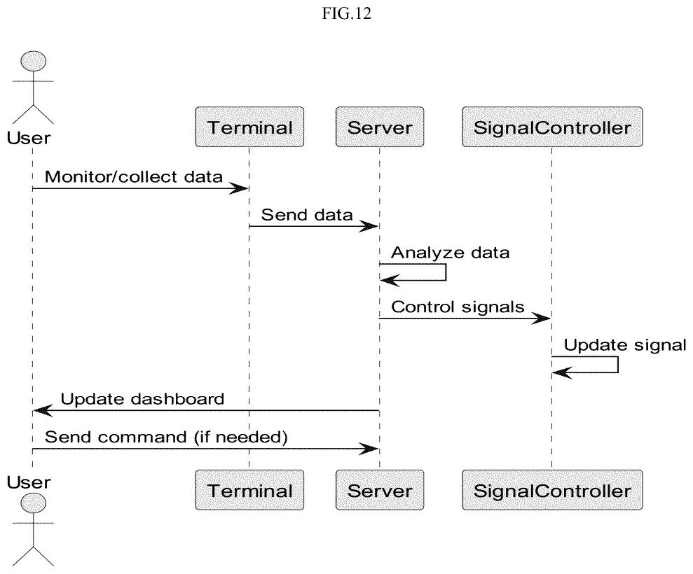

The following describes the processing flow using FIG. 12.

### Step 1:

The terminal (camera, weather sensor, and microphone) acquires raw data at a traffic intersection. The camera captures real-time video frames (e.g., 30 frames per second), the weather sensor measures temperature, humidity, and wind speed every minute, and the microphone records audio and facial data from nearby users.

Input: Real-world traffic and environmental conditions, user presence

Processing: Conversion of visual, environmental, and audio signals into digital data

Output: Raw video stream, weather sensor readings, and emotion data samples

### Step 2:

The terminal aggregates and packages the acquired video, weather, and emotion data. The terminal establishes a secure 5G connection to the server and streams the video using RTSP, while packaging weather and emotion data in structured formats such as JSON, and transmits them in real time.

Input: Raw video stream, weather sensor readings, emotion data samples

Processing: Data formatting, packaging, and establishing a wireless communication session

Output: Packaged video stream, encoded weather data, encoded emotion data sent to server

### Step 3:

The server receives the video stream and encoded data via the communication module, and stores each data type to a designated location in its distributed storage infrastructure.

Input: Packaged video stream, encoded weather data, encoded emotion data

Processing: Secure reception of data packets and database registration

Output: Raw data files stored in the server storage system

### Step 4:

The server analyzes the received video using a vehicle detection model implemented in OpenCV, extracts relevant objects (e.g., vehicles), and applies OCR (such as Tesseract) to detected license plates. The server computes traffic flow, detects vehicle violations, and creates a vehicle movement log.

Input: Raw video data

Data processing: Frame-by-frame image analysis, object recognition, license plate extraction and recognition

Output: Vehicle counts, violation detection log, identified license plates

### Step 5:

The server analyzes the received weather data using a time-series forecasting model such as ARIMA. The server predicts the likelihood of road freezing or other hazardous surface conditions over the coming period based on sensor data trends.

Input: Weather data (temperature, humidity, wind speed)

Data processing: Time-series analysis and environmental risk prediction

Output: Environmental risk forecast (e.g., road freezing risk score)

### Step 6:

The server processes emotion data using a combination of facial expression analysis (e.g., a CNN classifier) and voice analysis (e.g., OpenSMILE). The server estimates the emotional state of users at the intersection, categorizing them (e.g., as calm, stressed, or agitated).

Input: Facial video data, user audio samples

Data processing: Feature extraction and classification using emotion estimation models

Output: User emotion status for each location

### Step 7:

The server integrates the vehicle, violation, environmental, and emotion analysis results. The server determines optimal signal timing and notification methods, dynamically recalculating green light duration if congestion is detected, triggering emergency lights for incidents, and prioritizing alert notifications if high user stress is detected.

Input: Vehicle counts, violation log, environmental risk forecast, user emotion status

Data processing: Decision-making using rule-based and AI-based logic for dynamic control

Output: Signal control commands, notification instructions, system log

### Step 8:

The terminal (signal controller) receives the control commands from the server and physically adjusts the state of the signal lights, such as extending the green phase or activating emergency signals. The terminal may also activate local information panels or audio alerts in response to specific notification instructions.

Input: Signal control commands, notification instructions

Processing: Execution of hardware-level state changes and local alert protocols

Output: Updated signal status, localized user alerts

### Step 9:

The server updates the dashboard interface accessible by users (law enforcement or municipal staff). The dashboard displays real-time analytics, including live vehicle counts, detected incidents, environmental forecasts, and emotion metrics.

Input: Latest analysis and control results

Processing: Aggregation and visualization of analytic data for user interpretation

Output: Up-to-date dashboard accessible via secure remote login

### Step 10:

The user reviews the dashboard to monitor current traffic and environmental status, reviews user emotion data, and, when necessary, remotely issues commands such as enforcing traffic regulation or emergency response. The server receives the command, logs it, and applies it to the system, updating the control logic accordingly.

Input: Dashboard data, user-initiated command

Processing: User assessment and decision-making, command submission

Output: Executed system actions, audit trail

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

In conventional information display and control systems, it has been difficult to achieve real-time dynamic adaptation of system operations based on a comprehensive analysis of not only visible situational data and environmental conditions but also individual emotion states. Traditional systems are limited in their ability to mitigate congestion, respond promptly to hazardous conditions, and personalize notifications or operations according to the emotional state of individuals. As a result, there is a need for a system capable of integrating a wide range of sensory data in real time and promptly optimizing device control and user experience in complex environments.

The specific processing by the specific processing unit 290 of the data processing device 12 in Example 2 is realized by the following means.

The present invention provides a server including a processor configured to communicate with information communication devices, acquire visual and environmental information data, aggregate such data via a high-speed digital communication network, analyze the aggregated information, acquire individual condition information to analyze emotion states, and adaptively control notification or information device operations based on the analysis results. This enables real-time optimization of information device control and notification personalization based on comprehensive situational awareness, including individual emotional states, thereby improving overall system responsiveness, safety, and user experience.

The term “processor” refers to a hardware computational unit or an integrated circuit capable of executing programmed instructions to process input data and control associated devices.

The term “information communication device” refers to an electronic unit configured to transmit and receive data between an information display device and other system components via a communication network.

The term “information display device” refers to an apparatus capable of presenting visual, audio, or textual data to a user and interacting with control signals from a processor.

The term “information acquisition device” refers to any apparatus or sensor capable of collecting data such as visual images, audio, or environmental information from its surroundings.

The term “visual information data” refers to data representing images, video, or other visual content acquired from the environment by an information acquisition device.

The term “environmental information data” refers to data related to physical parameters of the surroundings, such as temperature, humidity, wind speed, or other environmental measurements.

The term “high-speed digital communication network” refers to a digital transmission system capable of conveying large volumes of data between devices or nodes with low latency, which may include cellular, wireless, or wired network technologies.

The term “information aggregation device” refers to a device or system component that collects, consolidates, and forwards data obtained from multiple information acquisition devices to a processor or server for analysis.

The term “information analysis device” refers to a computational unit or software that processes, interprets, and analyzes aggregated data, including visual and environmental information.

The term “control device” refers to hardware or software responsible for issuing control commands to one or more output devices such as information display devices, based on processed data.

The term “individual condition information” refers to data acquired from or about an individual that indicates physical, physiological, or behavioral conditions, including but not limited to biometric or emotional states.

The term “condition analysis device” refers to a computational module or program for processing and interpreting individual condition information to determine states, such as emotional or physical conditions.

The term “notification” refers to a message, alert, or signal delivered to a user or output device, typically to convey important information or prompt an action.

The term “operation of the information display device” refers to the manner in which the information display device presents data, interacts with users, or responds to control signals, including but not limited to displaying, updating, or modifying visual content.

The term “aggregation” refers to the collection and consolidation of multiple types of data from different sources into a unified dataset or packet for further processing.

The system according to the invention can be realized by integrating components including a server equipped with a processor, information communication devices, information acquisition devices, information aggregation devices, condition analysis devices, and information display devices interconnected by a high-speed digital communication network.

The terminal may include an image sensor, a microphone, an environmental sensor, and a local communication module. For example, the terminal may use a CMOS-based camera module for capturing visual information data, a digital microphone for acquiring user voice or audio data, and sensors for measuring environmental information data, such as temperature, humidity, or wind speed. The terminal may also contain a local processor and memory unit for temporary data storage and pre-processing, and a communication module compatible with wireless network standards (such as 5G).

The terminal collects visual information data by capturing image and video through the camera, acquires environmental information data through sensors, and captures individual condition information through audio and image input focused on facial and vocal characteristics. The terminal transmits these collected data sets to the server through the high-speed digital communication network, such as a 5G wireless network.

The server is typically realized using general-purpose computing hardware such as an industry-standard server unit (for example, with an x86 processor, memory, and storage) and runs an operating system such as Linux or Windows Server. The server executes an information analysis program composed of modules including computer vision libraries (such as OpenCV or TensorFlow), audio analysis software, environmental data parsers, and data aggregation software (such as Apache Kafka or custom middleware). For condition analysis, the server may utilize machine learning algorithms implemented within such frameworks to analyze facial expressions and analyze audio to determine the emotional or physiological state of the user.

The information aggregation device aggregates the data streams from multiple terminals, organizing and synchronizing them before forwarding them to the server for centralized analysis. The server's processor performs multi-modal data fusion: it processes the incoming visual, environmental, and individual data, identifies quantities and states of visible objects, detects rule-violating behavior (such as speeding or unauthorized access), and predicts hazardous states such as road icing based on environmental data.

The information display device can be a public information panel, vehicle-mounted display, or mobile device. The control device embedded in or associated with the server issues commands for adaptive operation of these information display devices. This includes dynamically adjusting the presentation of information, such as extending or shortening traffic light durations, displaying warnings or alerts, or personalizing notifications based on the emotional state of the user as determined by the analysis.

For example, when a terminal at an intersection detects high vehicle density, low temperatures, and high humidity, the system server may analyze the fused data and determine an elevated risk of road icing and driver stress due to congestion. The server directs the information display device at the intersection to extend the green light phase, show an ice warning, and issue a soothing audio message to drivers.

A typical prompt sentence to be input into a generative AI model for system explanation may be as follows:

“Explain step-by-step how a generative AI-enabled traffic management system integrates 5G communication, real-time sensor data (including traffic, weather, and user emotion), and dynamic server-side decision-making to control traffic lights and personalize user notifications.”

This implementation framework enables real-time optimization and adaptation of system behavior by allowing the server to process data holistically from a variety of sensors and user sources. The invention's structure is thus realized by widely available information technology and sensor hardware coordinated via appropriate software modules and communication protocols.

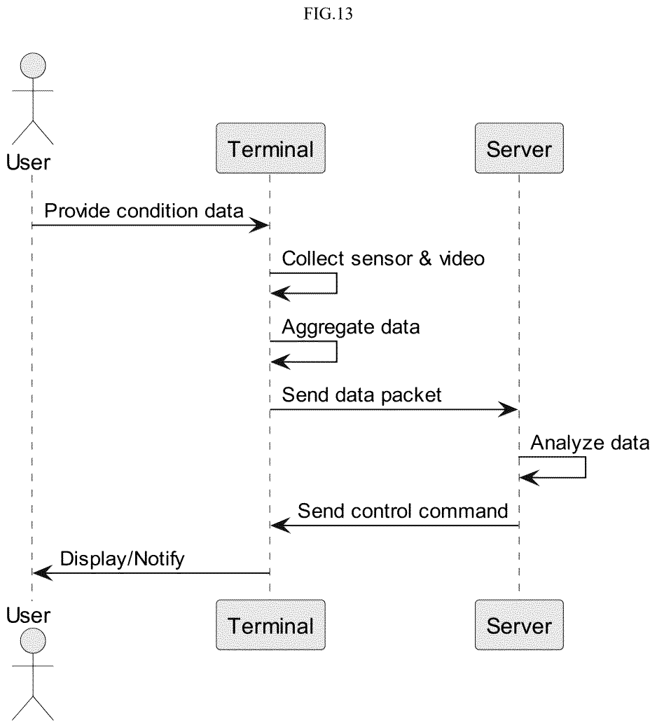

The following describes the processing flow using FIG. 13.

### Step 1:

The terminal collects visual information data, environmental information data, and individual condition information. The input to this step is the raw scene around the terminal, including images from a camera, sensor readings such as temperature and humidity, and user behavior detected by microphones and face sensors. Based on this input, the terminal converts video images into digital formats (such as MP4), sensor values into digital numerical records (such as JSON), and personal data (face and voice) into feature values suitable for emotional analysis. The output of this step is a data packet that includes processed visual data, environmental data, and individual condition data. For example, the terminal at an intersection captures 30 images per second, samples temperature and humidity every 60 seconds, and records a driver's voice when present.

### Step 2:

The terminal aggregates the collected data and prepares it for transmission. The input to this step is processed multimedia data (video, sensor readings, and personal feature data) obtained in Step 1. The terminal arranges this data into a unified data structure with timestamps, aggregates the various sensor streams, and temporarily stores the packet for consistency and reliability. The output is a timestamped, synchronized data packet ready for transmission. For example, the terminal combines video frames from 8:00:00 to 8:00:10, sensor values, and emotion-related records into an aggregated message.

### Step 3:

The terminal transmits the aggregated data packet to the server using a high-speed digital communication network. The input is the aggregated data packet from Step 2. The terminal uses wireless communication hardware (such as a 5G modem) to send this packet to the server. If transmission is interrupted, the terminal retries until confirmation is received. The output is the successful upload of the data packet to the server and deletion of the cached packet from local memory. For example, the terminal sends the packet via 5G, receives an acknowledgment from the server, and clears local storage.

### Step 4:

The server receives and analyzes the aggregated data packet from the terminal. The input to this step is the uploaded data packet containing visual, environmental, and individual data. The server uses software modules such as computer vision algorithms or deep learning models (for example, for object detection and face/voice analysis) to extract information about visible objects, environmental state, and emotional state. The server processes each stream: counts detected objects in images, predicts hazards based on environmental readings, and classifies user emotions from facial and audio features. The output is an integrated analysis result that represents the current situation at the terminal location. For example, the server identifies 25 vehicles, detects high accident risk from weather data, and recognizes user stress from voice and face data.

### Step 5:

The server determines the optimal response and generates control instructions for the information display device. The input is the integrated analysis result from Step 4. The server applies business rules or AI-based decision models to select actions, such as changing display messages, adapting notifications, or adjusting information display operation (such as signal light timing). The output is a command message for the information display device and a notification schedule for users. For example, the server decides to extend the green light duration and create an ice warning alert for drivers.

### Step 6:

The terminal receives instructions from the server and operates the information display device accordingly. The input to this step is the command message from the server, which may include updated display schedules, message content, and notification priorities. The terminal updates the display, alters notification patterns, or plays audio messages for users based on the server's instructions. The output is a dynamically controlled information display and timely notification to users. For example, the terminal activates an extended green light, displays an ice warning, and plays a calming audio message for drivers at the intersection.

### Step 7:

The user receives the notifications or visual/audio alerts and may interact with the terminal if appropriate (such as responding to prompts or submitting feedback). The input to this step is the operation and notification content displayed or sounded by the information display device. The user reacts to the system, which influences their driving behavior or comfort, and, in some cases, may enable feedback mechanisms for further data collection. The output is improved user awareness, potentially reduced stress, and system feedback for future optimization. For example, the user slows down due to an ice warning and feels reassured by the calming voice prompt.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional traffic management systems are limited in their capacity to comprehensively and dynamically respond to both environmental factors, such as traffic congestion and adverse weather conditions, and human-related factors, such as the emotional states of users, which can affect overall traffic safety and efficiency. Additionally, such systems are often unable to coordinate optimal control of signaling devices and the operation of mobile bodies like autonomous vehicles in real time, resulting in suboptimal road safety, traffic flow, and user satisfaction.

The specific processing by the specific processing unit 290 of the data processing device 12 in Application Example 2 is realized by the following means.

The present invention provides a server including a processor configured to receive and aggregate mobile body image data, environmental data, and user emotion data via a networked information communication device, analyze traffic conditions, environmental risks, and emotional states using artificial intelligence models, and dynamically control signaling devices and the operations of mobile bodies as well as adjust notification content for users based on these analyses. This enables real-time optimization of traffic management, enhanced road safety, improved autonomous vehicle control, and personalized communication with users according to their current emotional state and real-world conditions.

The term “processor” refers to a computing apparatus or unit that executes instructions to perform data processing, analysis, and control operations within the system. The term “information aggregation device” refers to a hardware unit or module that receives, collects, and temporarily consolidates data from multiple information acquisition devices before transmitting such data to the processor.

The term “information communication device” refers to a hardware component installed at a signaling device or other infrastructure, which enables data transmission between information acquisition devices, aggregation devices, and the processor via a communication network.

The term “signaling device” refers to an infrastructure element, such as a traffic signal or traffic light, that provides visual or audio cues to manage vehicular and pedestrian traffic flow.

The term “information acquisition device” refers to any type of sensor or hardware module—such as cameras, microphones, or environmental sensors—that obtains real-time data relevant to traffic, environmental conditions, or user status.

The term “mobile body” refers to a moving entity, such as a vehicle, including but not limited to autonomous vehicles, which can interact with the signaling device and the system.

The term “mobile body image information” refers to digital visual data acquired by an information acquisition device that captures the movement, status, or identification of a mobile body.

The term “environmental information” refers to data collected by an information acquisition device, including but not limited to temperature, humidity, wind speed, and other conditions affecting road safety or traffic flow.

The term “user” refers to an individual, such as a pedestrian or vehicle operator, whose behavior or emotional state may be relevant to the system's operation.

The term “emotional state information” refers to data describing the emotional status of a user, derived from sources such as facial image analysis or voice analysis.

The term “notification content” refers to the information, messages, or alerts generated by the system and transmitted to users, which may be adapted based on analysis results.

The term “artificial intelligence model” refers to any software framework, algorithm, or system capable of carrying out machine learning-based analysis, including but not limited to pattern recognition, prediction, or classification.

The term “environmental risk” refers to a potential hazard identified from environmental information, such as road freezing, snow accumulation, or severe weather conditions, which may affect traffic safety.

The term “traffic condition” refers to the state of vehicular movement, congestion, or incident occurrence within a target area, as determined by analysis of data from information acquisition devices.

### Embodiment for Implementing the Invention

The present invention can be implemented as a traffic management system including a processor, an information aggregation device, an information communication device, a plurality of information acquisition devices, a signaling device, and a user interface for notification. The system is configured to dynamically analyze traffic, environmental conditions, and user emotional states to optimize the control of signaling devices and mobile bodies, such as autonomous vehicles, thereby improving safety and efficiency in transportation networks.

A typical configuration includes:
1. Information acquisition devices: Terminals such as network cameras, environmental sensors (e.g., temperature, humidity, wind sensors), microphones, and user facial imaging devices are installed at intersections, roadways, or vehicles. For example, a network camera can be mounted to capture live video of traffic, while an environmental sensor, such as a combined temperature and humidity sensor, gathers weather data. A microphone and facial camera can obtain user voice and facial expression data.
2. Information aggregation device: A hardware gateway or edge computing terminal aggregates the collected data from the information acquisition devices. The aggregated data is time-stamped and formatted for transmission.
3. Information communication device and network: The aggregated data is transmitted via a high-speed communications network, such as 5G, to a central processor (server). The information communication device may be implemented as an embedded communication module installed with the signaling device.
4. Processor (Server): The server receives the data and is equipped with software modules, including image processing frameworks (such as OpenCV), object detection models (such as YOLOv5), license plate recognition tools, environmental data analysis modules (such as Python analytical libraries), emotional state analyzers (such as facial emotion recognition models and voice sentiment analysis tools), and a generative AI model for adaptive control and notification generation. The processor interprets the status of traffic and environment, predicts potential risks (including road freezing or accidents), identifies mobile bodies (including detecting violations), and determines the emotional states of users.
5. Signaling device and mobile body control: The signaling devices, such as traffic lights, receive control commands via the processor to adjust their state in real time according to analysis results. Mobile bodies, such as autonomous vehicles, may also receive commands to adjust their driving behavior, such as recommended speed reduction, lane changes, or alternative routing, particularly in response to congestion, hazards, or user stress.
6. Notification and user interface: The processor generates and sends real-time notifications through a user interface, such as a vehicle display or a mobile terminal application. The content of these notifications is personalized based on the emotional state and current context of the user. For example, in response to user stress and congestion, a calming message may be displayed and routing suggestions may be provided.

A practical example is as follows.

During rush hour at a city intersection, a network camera collects video at 30 frames per second, while an environmental sensor measures 2° C. and 80% humidity. Microphones and cameras record user faces and voices for emotion analysis. The data aggregation device transmits all data via a high-speed network to the server. The server employs computer vision to count vehicles and identify violations, analyzes weather data for freezing risk, and evaluates user stress levels using both facial and voice analysis tools. If high congestion, freezing risk, and user stress are detected, the processor extends the green light signal, instructs vehicles to drive cautiously, and sends users a personalized alert message such as, “Heavy congestion ahead—please relax. The traffic signal has been adjusted for smoother flow. Drive carefully, icy road risk detected.”

An example prompt sentence for operation simulation or generating notification content with a generative AI model is as follows.

“Simulate an urban traffic management scenario where terminal devices collect real-time video, weather, and user emotion data; the server analyzes the data using AI models; and based on congestion, road condition, and user stress, dynamically adjusts signal control and autonomous vehicle behavior. Provide users with targeted notifications determined by current emotion analysis results.”

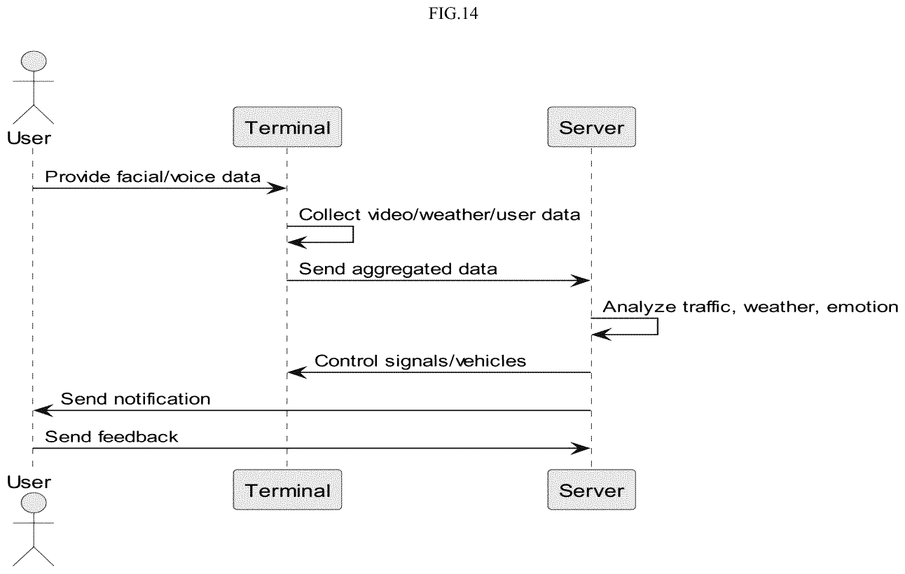

The following describes the processing flow using FIG. 14.

### Step 1:

Terminal collects real-time data, including video footage from cameras, environmental data from weather sensors (such as temperature, humidity, and wind speed), and user facial/voice data from microphones and facial imaging devices placed at intersections or within vehicles. The input data for this step is raw, unprocessed signals from all acquisition devices. Terminal formats and structures this data, assigning accurate timestamps and device identifiers. The output is a structured data package containing synchronized video files, sensor readings, and user-related media files.

### Step 2:

Terminal transmits the structured data package to the information aggregation device, which acts as a local gateway. Terminal compresses video and audio files using standard codecs (such as H.264 for video and AAC for audio) and bundles all sensor and user data into a unified transmission packet. The input is the structured data package from the previous step; the output is a compressed, aggregated data packet suitable for high-speed network transmission.

### Step 3:

Terminal sends the aggregated data packet via the information communication device using a high-speed network (such as 5G). The input is the compressed data packet; the output is secure transmission to the central server for real-time analysis.

### Step 4:

Server receives the aggregated data packet and initiates data parsing and allocation. Server unpacks the transmission packet into separate queues: one for traffic video, one for environmental data, and one for user facial/voice data. The input for this step is the multi-stream aggregated packet, and the output is separated and pre-processed data streams ready for analytical processing.

### Step 5:

Server analyzes the traffic video stream using computer vision software and object detection algorithms (such as YOLOv5) to detect and count vehicles, track vehicle movements, and identify abnormal traffic events or violations (such as speeding or red-light running). The input is raw video data, and the output is metadata describing vehicle positions, counts, and detected events.

### Step 6:

Server analyzes environmental sensor data using a data analytics module (for example, written in Python), which calculates risks such as road freezing or poor visibility based on thresholds (e.g., temperature below zero and high humidity). Server processes the input environmental data to output a risk assessment score for hazardous road conditions.

### Step 7:

Server analyzes user facial images and voice data using emotion recognition frameworks, such as facial expression classifiers and speech emotion analysis models. The input includes image and audio data of users; the server outputs an emotional state assessment (e.g., calm, stressed, angry) and computes an aggregate emotional state for all users in the area.

### Step 8:

Server integrates the results from traffic, environmental, and emotional analyses using a generative AI model or rule-based decision logic. Server determines optimal signal timing and mobile body (such as autonomous vehicle) behavior adjustments based on current congestion, hazard level, and user stress. The inputs are analysis results from previous steps; the outputs are real-time control commands for signaling devices and autonomous vehicle operation instructions.

### Step 9:

Server generates personalized notifications for users, determining the content and delivery style based on emotional status and contextual needs. For example, users under stress receive simplified, calming instructions, while others receive more detailed information. The input is the user emotional state combined with traffic and environmental context; the output is a tailored notification message sent to user devices (such as smartphones or vehicle displays).

### Step 10:

User receives the notification and may interact with the system, for instance, by confirming the message or requesting more information via the user interface. The input is the delivered notification; the output may include user feedback, which the server collects for future system adaptation and improvement.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

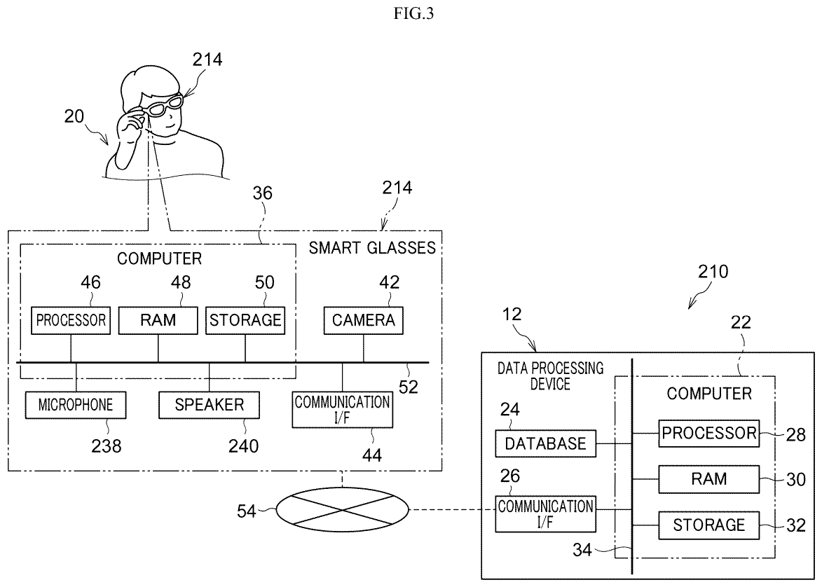

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

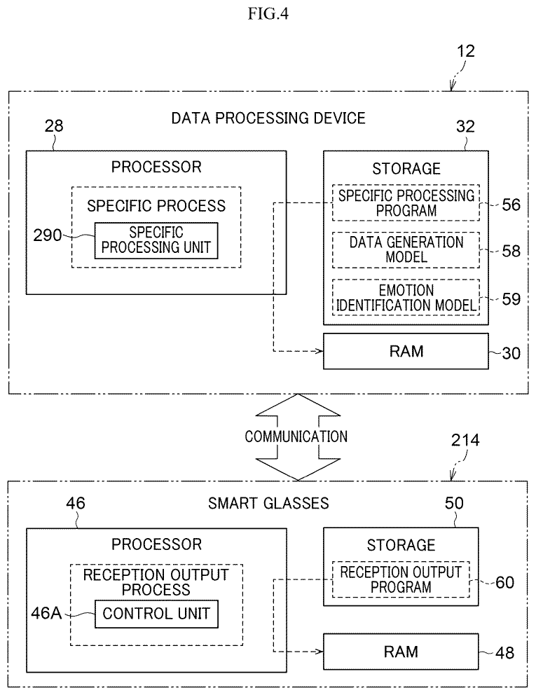

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

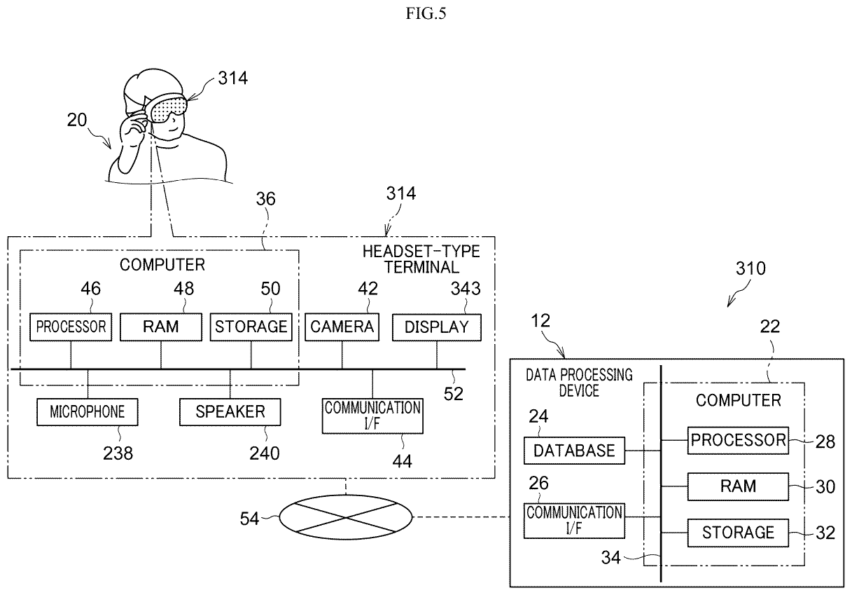

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

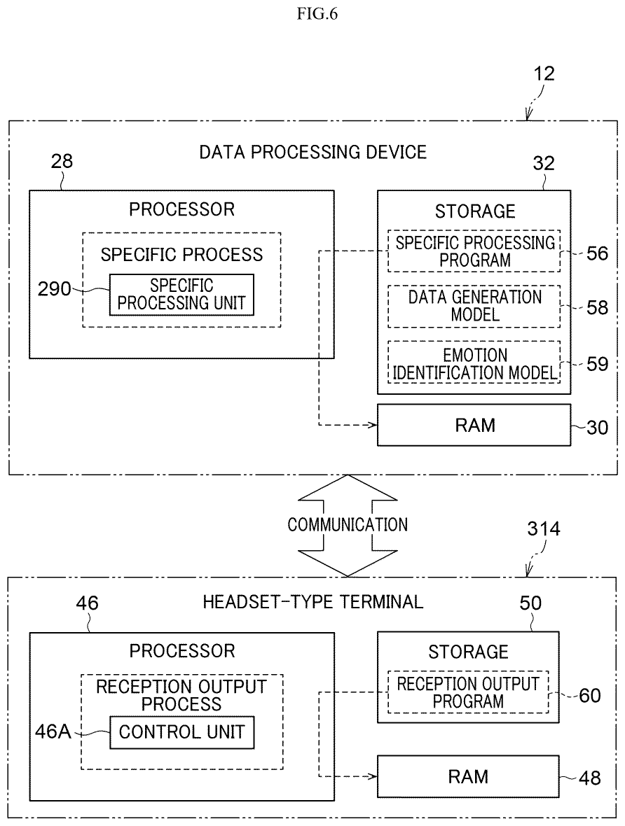

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

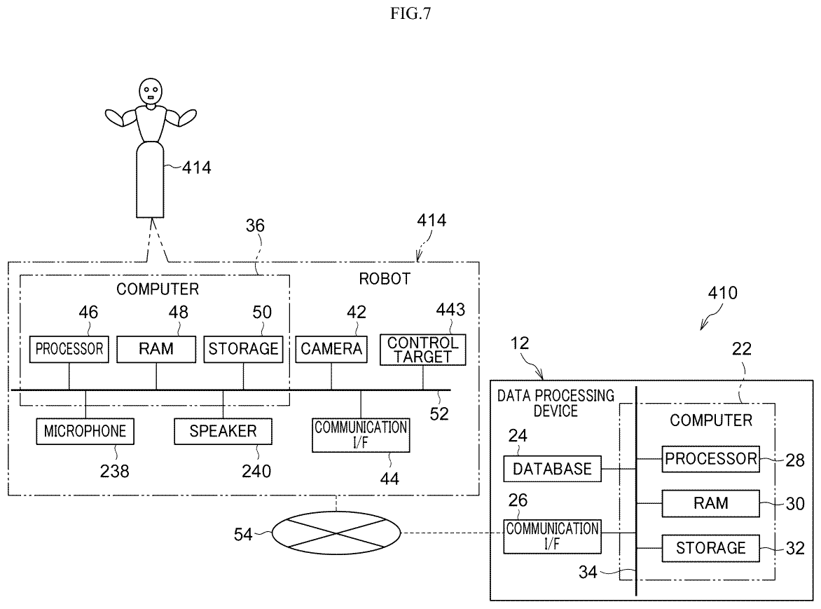

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

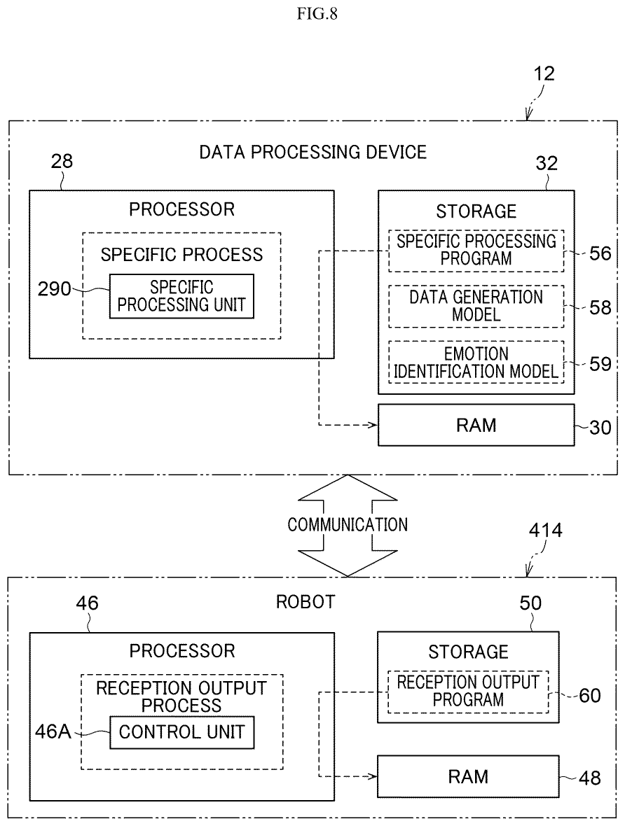

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

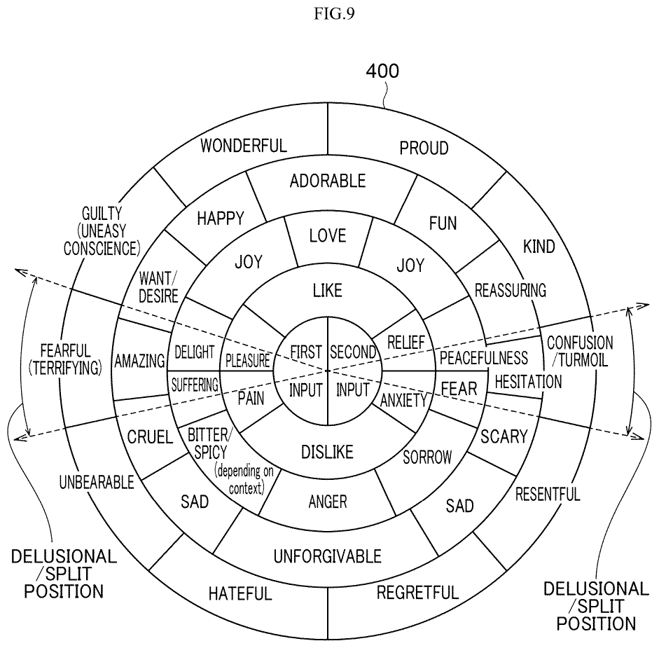

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

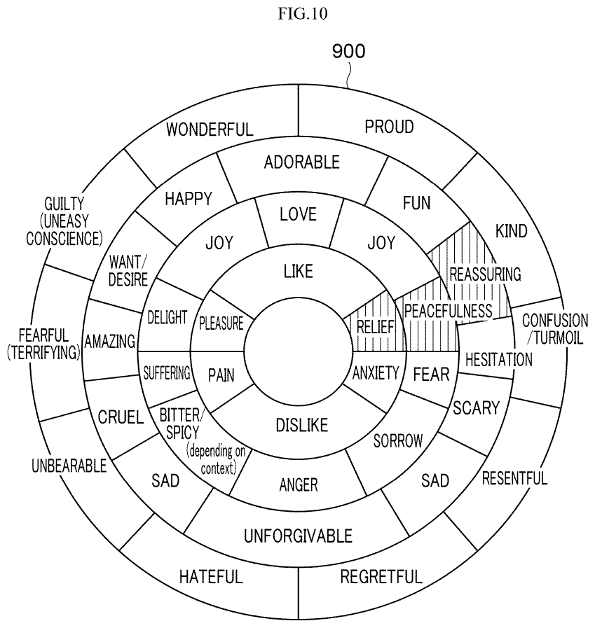

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system including a processor,
wherein the processor is configured to
acquire information from a data recording device via a communication platform installed in a traffic control device,
collect multiple types of traffic information data and environmental information data using a plurality of measurement devices,
aggregate data collected from the measurement devices through a data transmission device and a data storage device over a high-speed communication network,
perform time-series alignment and data inconsistency resolution processing and provide the aligned data to an analysis device,
execute image recognition processing and situation analysis using a machine learning model with the analysis device,
extract vehicle identification information by using character recognition technology, remotely control traffic control equipment based on the analysis result, and
display visualization information in real time and provide an operational interface to a user.

### (Supplementary 2)

The system according to supplementary 1,
wherein the processor is configured to
identify traffic situations using an object detection algorithm and identification technology,
predict road surface conditions from environmental information data using a machine learning model,
and cross-reference identification information with violation target information management means.

### (Supplementary 3)

The system according to supplementary 1,
wherein the processor is configured to
dynamically change signal control information for traffic control equipment based on the analysis result, and
execute emergency response control and route optimization according to traffic conditions.

### Application Example 1

### (Supplementary 1)

A system including a processor,
wherein the processor is configured to
receive information acquired from an information acquisition unit installed in a signal control area through a communication module,
store image information acquired by the information acquisition unit,
store environmental information acquired by the information acquisition unit,
temporarily aggregate the image information and environmental information received from the information acquisition unit using an aggregation module, and transmit the aggregated information to an analysis module,
analyze the image information and environmental information received from the aggregation module using an information analysis module, and output the analysis result to a control module to control the state of a signal display module based on the analysis result,
estimate human emotion state by using an emotion estimation model based on data obtained by the information acquisition unit,
dynamically change the control of the signal display module and a notification method in accordance with the analysis result and the estimated emotion state,
enable visualization of information and operation command input via a terminal or operation device,
allow a remote user to view the acquisition status, analysis status, and emotion status through the information visualization function and to execute commands.

### (Supplementary 2)

The system according to supplementary 1,
wherein the processor is configured to
analyze movement of an object in the image information, identify a non-compliant moving object, predict surface status based on environmental information, and classify emotion state using an emotion estimation model.

### (Supplementary 3)

The system according to supplementary 1,
wherein the processor is configured to
automatically adjust the display status of the signal display module and the notification method in accordance with the analysis result of the image information, environmental information, and emotion information, and to implement individual notifications and traffic flow control for users.

### Example 2

### (Supplementary 1)

A system including a processor,
wherein the processor is configured to
communicate with an information communication device installed in an information display device,
acquire visual information data through an information acquisition device,
acquire environmental information data through an information acquisition device,
aggregate data from the information acquisition devices via a high-speed digital communication network through an information aggregation device,
analyze information transmitted from the information aggregation device using an information analysis device,
control the operation of the information display device based on analysis results from the information analysis device,
acquire individual condition information and analyze individual emotion states using a condition analysis device, and
adaptively control notification or operation of the information display device based on analysis results from the condition analysis device.

### (Supplementary 2)

The system according to supplementary 1,
wherein the processor is configured to
identify quantities of visual information and accident states,
identify rule-violating targets within the visual information, and
predict hazardous states based on environmental information.

### (Supplementary 3)

The system according to supplementary 1,
wherein the processor is configured to
dynamically change operation states of the information display device to mitigate congestion conditions of the visual information and to respond to accidents, and
adaptively control notification or operation of the information display device based on individual emotional states.

### Application Example 2

### (Supplementary 1)

A system including a processor,
wherein the processor is configured to
receive data inputted from an information aggregation device, the information aggregation device being connected via an information communication device installed at a signaling device and receiving mobile body image information and environmental information from one or more information acquisition devices,
analyze the behavior of a mobile body and environmental state based on the received data,
control the signaling device and/or the operation of the mobile body based on analysis results,
acquire and analyze emotional state information of a user, and
adjust notification content presented to the user according to the user's emotional state.

### (Supplementary 2)

The system according to supplementary 1,
wherein the processor is configured to
perform analysis of the mobile body behavior, identification of the mobile body, prediction of environmental risk, and user emotion analysis by using an artificial intelligence model.

### (Supplementary 3)

The system according to supplementary 1,
wherein the processor is configured to
dynamically control the display state of the signaling device and driving operations of the mobile body based on the traffic condition, environmental risk, and user emotional state.

What is claimed is:

1. A system comprising a processor,
wherein the processor is configured to:
collect traffic video data using a data acquisition device installed at a traffic signal,
collect weather data using a data acquisition device,
aggregate data from the data acquisition devices via a high-speed communication network using a data aggregation device,
analyze the data transmitted from the data aggregation device using an analysis unit, and
control the traffic signal based on analysis results from the analysis unit.

2. The system according to claim 1, wherein the processor includes:
means for identifying traffic volume and traffic accidents,
means for identifying traffic violation vehicles, and
means for predicting road freezing or snowfall.

3. The system according to claim 1, wherein the processor includes means for dynamically changing the lighting state of the traffic signal for alleviating traffic congestion and responding to traffic accidents.
